(19) United States
(12) Patent Application Publication
(10) Pub. No.: US 2022/0146879 A1
(43) Pub. Date: May 12, 2022

(54) BACKLIGHT COMPRISING LIGHT GUIDE PLATE, RESULTING DISPLAY DEVICE, METHOD OF MAKING AND METHOD OF USING THE SAME

(71) Applicant: CORNING INCORPORATED, CORNING, NY (US)

(72) Inventors: Kirk Richard Allen, Elmira, NY (US); Alexander Lee Cuno, Sayre, PA (US); Xiang-Dong Mi, Pittsford, NY (US); Jinfa Mou, Pittsford, NY (US)

(21) Appl. No.: 17/297,118

(22) PCT Filed: Nov. 21, 2019
(86) PCT No.: PCT/US2019/062556

§ 371 Date: May 26, 2021

Related U.S. Application Data
(60) Provisional application No. 62/825,207, filed on Mar. 28, 2019.
(60) Provisional application No. 62/773,593, filed on Nov. 30, 2018.

(51) Int. Cl. G02F 1/13357; F21V 8/00; G02F 1/1333

(52) U.S. Cl. CPC G02F 1/133603; G02B 6/0065; G02B 6/0068; G02B 6/0073; G02F 1/133615; G02B 6/0088; G02F 1/133305

(57) ABSTRACT

A backlight unit is provided for a liquid crystal display (LCD) unit in a display device. The backlight unit includes a light guide plate (LGP) and a first light source. The light guide plate has two major surfaces and a first side wall surface between the two major surfaces. The first light source is contact with or in proximity to the first wall surface of the light guide plate and optically coupled with the light guide plate. The light guide plate has a dimension such as length greater than a dimension such as length for the LCD unit. The first light source has a dimension such as length equal to or greater than the dimension such as length for the LCD unit.

### CROSS-REFERENCE TO RELATED APPLICATIONS

This application claims the benefit of priority under 35 U.S.C. § 119 of U.S. Provisional Application Ser. No. 62/825,207 filed on Mar. 28, 2019 and U.S. Provisional Application Ser. No. 62/773,593 filed on Nov. 30, 2018, the content of which are relied upon and incorporated herein by reference in their entirety.

### FIELD OF THE INVENTION

The disclosure relates to light guide plates and resulting display devices generally. More particularly, the disclosed subject matter relates to a light guide plate, a backlight comprising such a light guide plate, and a resulting display device.

### BACKGROUND

Liquid crystal displays (LCDs) are used in various electronics, such as cell phones, laptops, electronic tablets, televisions, and computer monitors. LCDs can comprise a backlight unit (BLU) for producing light, which can then be converted, filtered, and/or polarized to produce desired images. However, compared to other display devices, LCDs may have limitations in brightness, contrast ratio, efficiency, and viewing angle. There is a continuing demand for improved brightness, contrast ratio, and color gamut, with a balance in power requirements and device size (e.g., thickness).

Automotive displays may include a variety of display types such as LCDs, and are used as instrument cluster displays, center stack displays, head-up displays, rear seat entertainment displays, and electronic-mirror displays. Due to wide driving conditions, such automotive displays need to survive high-low temperature and humidity cycles. Those displays also need to be bright enough to allow sunlight readability. Recent automotive displays are evolving toward 1000 nits or more to achieve this performance.

In addition to conventional flat and rigid display devices, curved and/or flexible display devices are also in high demand. The light guide plates and the back light units are mostly inflexible.

Accordingly, it would be advantageous to provide curved and/or flexible display devices such as automotive displays with a backlight that can be flexible, and provide good brightness and sunlight readability.

### SUMMARY OF THE INVENTION

The present disclosure provides a backlight unit for a liquid crystal display (LCD) unit in a display device, a resulting display device, a method of making and a method of using the backlight unit or the display device.

In accordance with some embodiments, the backlight unit comprises a light guide plate (LGP) and a first light source. The LGP has a first major surface, a second major surface opposite to the first major surface, and a first side wall surface between the first major surface and the second major surface. The first light source is in contact with or in proximity to the first side wall surface, and is optically coupled with the LGP. In some embodiments, the LGP has a dimension such as length greater than a pre-determined dimension such as length for the LCD unit. For example, a ratio of the length of the LGP to the length of the LCD unit is 1.2 or higher. Examples of a range for such as ratio include, but not limited to, 1.2-3, 2-3, 3-5, or any suitable range. The LGP may have a size much larger than that of one LCD unit. The LGP can be used to illuminate two or more LCD units. The first light source has a dimension such as length equal to or greater than the pre-determined dimension such as length for the LCD unit. In some embodiments, the length of the LGP may be greater than the length of the first light source.

The light guide plate (LGP) may comprise or is made of a material selected from the group consisting of a glass, a polymer, and a combination thereof. The LGP is transparent with high light transmittance, and may be configured for both flexible and rigid displays. In some embodiments, the LGP comprises or is made of a strengthened glass. Such a glass is strengthened chemically through ion exchange, thermally, or both chemically and thermally. The LGP has a thickness in a range of from about 0.01 mm to about 6 mm, for example, from about 0.01 mm to about 0.6 mm, about 0.01 mm to about 0.7 mm, or from about 0.01 mm to about 1.6 mm, or any other suitable range. The LGP is configured to be dynamically bendable to a minimum radius of curvature of about 100 mm. For example, the radius of curvature may be in a range of from about 100 mm to about 10,000 mm, from about 100 mm to about 5,000 mm, from about 100 mm to about 4,000 mm, from about 100 mm to about 3,000 mm, from about 100 mm to about 2,000 mm, from about 100 mm to about 1,000 mm, from about 100 mm to about 400 mm, from about 200 mm to about 400 mm, from about 100 mm to about 500 mm or any other suitable range.

In some embodiments, the LGP is made of any glass having any suitable thickness for rigid display applications. In some embodiments, the LGP is made of a polymer having a suitable thickness for both flexible and rigid display application.

In some embodiments, the light guide plate further comprises a second side wall surface opposite the first sidewall surface, and the backlight unit comprises a second light source contacting or in proximity to the second side wall surface and optically coupled with the light guide plate. Each light source is disposed along a direction of the length (i.e., the longer side) of the LCD screen or the LGP. A third light source may be also disposed along the width direction of the LCD screen or the LGP. This configuration may be used in combination with the two light sources disposed along the length direction of the LCD screen or the LGP.

In some embodiments, each light source comprises a plurality of discrete light emitting diodes (LED). Each discrete LED has a length (Pw). The plurality of discrete LEDs are disposed in a repeating pattern with a unit dimension or pitch (P) at a ratio of Pw/P in a range of from 0.5 to 0.95 (e.g., from 0.75 to 0.86). The pitch (P) includes the length of one LED and the gap between two adjacent LEDs.

In one aspect, the present disclosure provides a display device, which comprises a LCD unit, and a backlight unit as described herein. The LGP has a first major surface, a second major surface opposite to the first major surface, and a first wall surface between the first major surface and the second major surface. A first light source contacts or is in proximity to the first side wall surface, and is optically coupled with the light guide plate. The LGP has a dimension such as length greater than a dimension such as length of the LCD unit. The first light source has a dimension such as length equal to or greater than the length of the LCD unit. The length of the LGP may be greater than the length of the first light source.

In some embodiments, the light guide plate has a dimension such as length much larger than that of the dimension such as length of the LCD unit, and is configured to illuminate one or more additional LCD units.

The light guide plate (LGP) may comprise or is made of a material selected from the group consisting of a glass, a polymer, and a combination thereof. For example, in some embodiments, the LGP comprises or is made of a chemically or thermally strengthened glass. The LGP has a thickness in a range of from about 0.01 mm to about 0.7 mm, and is configured to be dynamically bendable to a minimum radius of curvature of 500 mm or less, or about 100 mm to about 500 mm. The radius of curvature may be in a range of from 100 mm to 1,000 mm (e.g., 100-400 mm or 200-400 mm). The gap between a light source and a side wall surface may be less than about 0.01 mm. The light source may directly contact the side wall surface of the LGP in some embodiments.

In some embodiments, each light source comprises a plurality of discrete LEDs. Each LED has a length (Pw). The plurality of discrete LEDs are disposed in a repeating pattern with a unit dimension (P) at a ratio of Pw/P in a range of from 0.5 to 0.95 (e.g., from 0.75 to 0.86).

The display device further may comprise one or more components such as a light extractor, a reflector, at least one prismatic film, touch panel, a cover lens, and combinations thereof.

In accordance with some embodiments, the display device as described includes a LGP made of glass, and may be configured for curved or flexible display applications in any suitable field such as automotive display application. In some embodiments, such a device comprises at least one LCD unit and a backlight unit. The backlight unit comprises a LGP and a first light source. The LGP has a first major surface, a second major surface opposite to the first major surface, and a first side wall surface between the first major surface and the second major surface. The first light source contacts or is in proximity to a first side wall surface. The light guide plate has a dimension such as length greater than a dimension such as length of the at least one LCD unit. The first light source has a dimension such as length equal to or greater than that of the at least LCD unit. The LGP is made of glass. In some embodiments, the LGP has a thickness in a range of from about 0.01 mm to about 0.7 mm, and is configured to be dynamically bendable to a minimum of radius of curvature of 100 mm, for example, in a range of from 100 mm to 1,000 mm or from about 100 mm to about 500 mm. In some embodiments, the light guide plate further comprises a second side wall surface opposite the first sidewall surface, and the backlight unit comprises a second light source contacting or in proximity to the second side wall surface and optically coupled with the LGP.

In some embodiments, each light source comprises a plurality of discrete LEDs, which are disposed in a repeating patter with a unit dimension or pitch (P) at a ratio of Pw/P in a range of from 0.5 to 0.95 (e.g., from 0.75 to 0.86), where Pw is a length of each LED.

In another aspect, the present disclosure provides a method of making the backlight unit or a method of making the display device as described herein. Such a method of making the display device comprises providing the LCD unit, forming the backlight unit, and assembling the backlight unit and the LCD unit so as to form the display device.

In another aspect, the present disclosure provides a method of using the backlight unit or a method of using the display device as described herein. Such a method comprises a step of bending the display device so that the light guide plate in the backlight unit is bent from a flat position or from a first radius of curvature to a second radius of curvature. One of the first or the second radius of curvature may be in a range of from about 100 mm to about 1,000 mm (e.g., 100-400 mm or 200-400 mm).

The resulting backlight unit and the resulting display device as described herein have high luminance. For example, in some embodiments, the backlight unit has a luminance in a range of from about 15,000 nits to about 68,000 nits, and the display device has a luminance in a range of from about 1,000 nits to about 4,700 nits, at a current in a range of from about 10 mA to 30 mA. In addition to excellent brightness, the backlight and display device have other performance such as thermal stability.

The products provided in the present disclosure can be used in various applications. For example, in some embodiments, the products are automotive displays that include a flexible backlight, which includes a glass light guide plate that is capable of dynamic bending and sunlight readability.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1A is a perspective view illustrating an exemplary flexible display device in accordance with some embodiments.

FIG. 1B is a plan view illustrating an exemplary flexible display device having an exemplary backlight unit, which comprises a light guide plate (LGP) and one light source in accordance with some embodiments.

FIG. 1C is a plan view illustrating an exemplary flexible display device having an exemplary backlight unit, which comprises a light guide plate (LGP) and two light sources in accordance with some embodiments.

FIG. 1D is a sectional view illustrating the exemplary flexible display device of FIG. 1D (along line A-A′) in accordance with some embodiments.

FIG. 2A is a plan view illustrating an exemplary display device having exemplary dimensions in accordance with some embodiments.

FIG. 2B is a magnified view of an exemplary portion of one light source in the exemplary display device of FIG. 2A in accordance with some embodiments.

FIG. 3 is a plan view illustrating performance of an exemplary prototype backlight unit in some embodiments.

FIG. 4 illustrates spatial luminance distribution of the prototype backlight unit of FIG. 3 along the vertical and horizontal directions

FIGS. 5A-5C are plan views illustrating performance of an exemplary prototype backlight unit when one or two light sources are turned on in accordance with some embodiments.

FIG. 6 illustrates spatial luminance distribution of the prototype backlight unit of FIG. 5A-5C (having a ratio of L_{LED}/L_{LCD} of about 1.93) along the center horizontal line (B-B′) when one or two light sources are turned on in accordance with some embodiments.

FIG. 7 illustrates spatial luminance distribution of the prototype backlight of FIG. 5A-5C (having a ratio of L_{LED}/L_{LCD} of about 1) along the center horizontal direction (B-B′) when one or two light sources are turned on in accordance with some embodiments.

FIG. 8 is a perspective view illustrating an exemplary apparatus used to change a radius of curvature of an exemplary light guide plate in accordance with some embodiments.

FIGS. 9A-9B are sectional views illustrating that an exemplary light guide plate is dynamically bent with a first radius of curvature (R1) and a second radius of curvature (R2) in accordance with some embodiments.

FIG. 10 is a flow chart illustrating an exemplary method of making an exemplary display device in accordance with some embodiments.

FIG. 11 a flow chart illustrating an exemplary method of using an exemplary display device in accordance with some embodiments.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

Automotive displays are trending toward a curved form factor, which can include a curved cover substrate. The backlight unit (BLU) used in such displays may be flat or curved. A curved cover substrate allows wider possibilities for more immersive integration of displays into an automotive interior design. Compared to displays with flat cover substrate, curved displays require special materials, processing equipment and novel metrology technique. To meet high technical specification requirements of automotive industry, curved automotive displays face technical challenges as stress-induced corner light leakage and corner mura. Meanwhile, curved displays must maintain high luminance uniformity of the backlight and mechanical reliability in a curved shape, and are expected to have desired small thickness, and with two-dimensional (2D) local dimming capability.

More advanced automotive displays are moving toward a dynamically bendable form factor, meaning that the radius of curvature can vary depending on the user's selection. In contrast, the curved form factor mentioned above requires only fixed radius of curvature.

Liquid crystal displays (LCDs) can be flat or curved. Curved LCDs benefit from curved BLUs in terms of better conformity. Curved BLUs can include a plastic light guide plate (LGP), sometimes also referred to as a light guide film (LGF). Plastic LGP based BLUs can be flexible when the thickness of the LGP thickness is small, for example, thinner than 0.7 mm. Thin plastic LGP may be made of poly(methyl methacrylate) (PMMA) or polycarbonate (PC).

Thin plastic LGP based BLUs may not produce high luminance that enables sunlight readability for an automotive display because high flux and small LEDs are required. Considerable heat generated from the light-emitting diodes (LEDs) can cause warpage in the plastic LGP. To reduce the thermal impact, a gap between the LEDs and the plastic LGP is kept sufficiently large, resulting low optical coupling efficiency and lower luminance.

On the other hand, high brightness BLUs enabling sunlight readability can be made of thick plastic LGP that may be thicker than 2 mm or 3 mm. Thick LGPs allow larger LEDs to be used; however, at such thicknesses, LGPs are brittle and not flexible to allow dynamic bending.

The present disclosure provides a backlight unit for a liquid crystal display (LCD) unit in a display device, a resulting display device, a method of making and a method of using the backlight unit or the display device. The backlight and resulting display device are provided to meet the challenges faced in different applications. For example, in some embodiments, the present disclosure provides a display device including a flexible backlight, which includes a glass LGP that is capable of dynamic bending and sunlight readability. The related descriptions are for illustration only. The products provided in the present disclosure may also include glass based LGP for curved display and rigid displays, and may include polymer based LGP for both flexible and rigid displays.

The terms “backlight” and “backlight unit” are used interchangeably in the present disclosure. Unless expressly indicated otherwise, the term “backlight” or “backlight unit” used herein is understood to encompass an apparatus or a form of illumination providing light for a display that illuminates the display from the back of the display.

The LGP is transparent or substantially transparent. As used herein, the term “transparent” is intended to denote that the LGP, at a thickness of approximately 1 mm, has a transmission of greater than about 85% in the visible region of the spectrum (400-700 nm). For instance, an exemplary transparent LGP may have greater than about 85% transmittance in the visible light range, such as greater than about 90%, greater than about 95%, or greater than about 99% transmittance, including all ranges and subranges therebetween. According to various embodiments, the LGP may have a transmittance of less than about 50% in the visible region, such as less than about 45%, less than about 40%, less than about 35%, less than about 30%, less than about 25%, or less than about 20%, including all ranges and subranges therebetween. In certain embodiments, an exemplary LGP may have a transmittance of greater than about 50% in the ultraviolet (UV) region (100-400 nm), such as greater than about 55%, greater than about 60%, greater than about 65%, greater than about 70%, greater than about 75%, greater than about 80%, greater than about 85%, greater than about 90%, greater than about 95%, or greater than about 99% transmittance, including all ranges and subranges therebetween.

Unless expressly indicated otherwise, the term “optically coupled” used herein is understood to mean that two or more components or device are interconnected to transfer light wave and/or an optical signal. For example, when a light source is optically coupled with a light guide plate, the light emitted from the light source is transferred or coupled into the light guide plate.

Unless expressly indicated otherwise, the term “glass article” or “glass” used herein is understood to encompass any object made wholly or partly of glass. Glass articles include monolithic substrates, or laminates of glass and glass, glass and non-glass materials, glass and crystalline materials, and glass and glass-ceramics (which include an amorphous phase and a crystalline phase). Unless otherwise specified, all glass compositions are expressed in terms of mole percent (mol. %) on an oxide basis.

A “stress profile” is a plot of stress with respect to position of a strengthened glass article. A compressive stress (CS) region, where the glass article is under compressive stress, extends from a first surface to a depth of compression (DOC) of the article. A central tension region extends from the DOC into the central portion of the glass article and includes the region where the glass article is under tensile stress.

As used herein, depth of compression (DOC) refers to the depth at which the stress within the glass article changes from compressive to tensile stress. At the DOC, the stress crosses from a positive (compressive) stress to a negative (tensile) stress and thus exhibits a stress value of zero. According to the convention normally used in mechanical arts, compression is expressed as a negative (<0) stress and tension is expressed as a positive (>0) stress. Throughout this description, however, compressive stress (CS) and central tension (CT) is expressed as a positive or absolute value—i.e., as recited herein, CS=|CS| and CT=|CT|. Maximum central tension (maximum CT or CTₘₐₓ) refers to the maximum tensile stress in the central tension region. Maximum compressive stress (maximum CS or CTₘₐₓ) refers to the maximum CS stress in the CS region.

As used herein, the terms “depth of exchange,” “depth of layer” (DOL), “chemical depth of layer,” and “depth of chemical layer” may be used interchangeably, describing in general the depth, at which ion exchange facilitated by an ion exchange process (IOX) takes place for a particular ion. DOL refers to the depth within a glass article (i.e., the distance from a surface of the glass article to its interior region), at which an ion of a metal oxide or alkali metal oxide (e.g., the metal ion or alkali metal ion) diffuses into the glass article where the concentration of the ion reaches a minimum value, as determined by Glow Discharge-Optical Emission Spectroscopy (GD-OES)). In some embodiments, the DOL is given as the depth of exchange of the slowest-diffusing or largest ion introduced by an ion exchange (IOX) process.

Unless otherwise specified, CT and CS are expressed herein in megaPascals (MPa), thickness is express in millimeters, and DOC and DOL are expressed in microns (micrometers).

CS at the surface is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

The maximum CT value is measured using a scattered light polariscope (SCALP) technique known in the art.

DOC may be measured by FSM or SCALP depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP. It is believed the exchange depth of sodium indicates the DOC and the exchange depth of potassium ions indicates a change in the magnitude of the compressive stress (but not the change in stress from compressive to tensile). The exchange depth (or DOL) of potassium ions in such glass articles is measured by FSM.

Refracted near-field (RNF) method may also be used to measure attributes of the stress profile. When the RNF method is utilized, the maximum CT value provided by SCALP is utilized. In particular, the stress profile measured by the RNF method is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

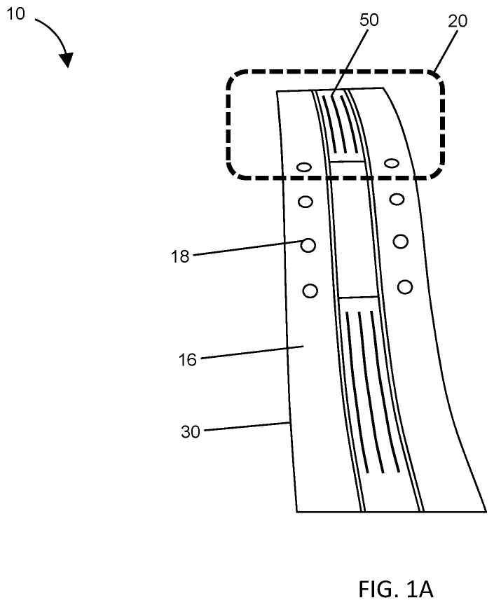

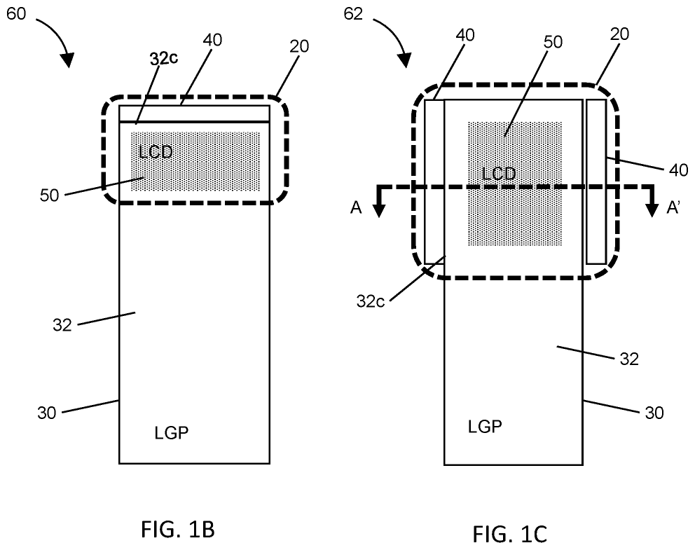

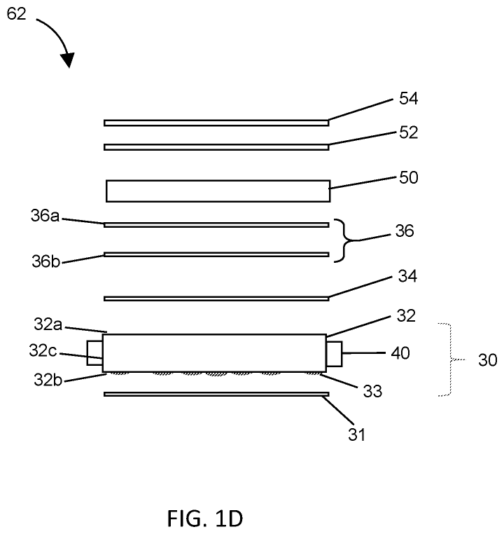

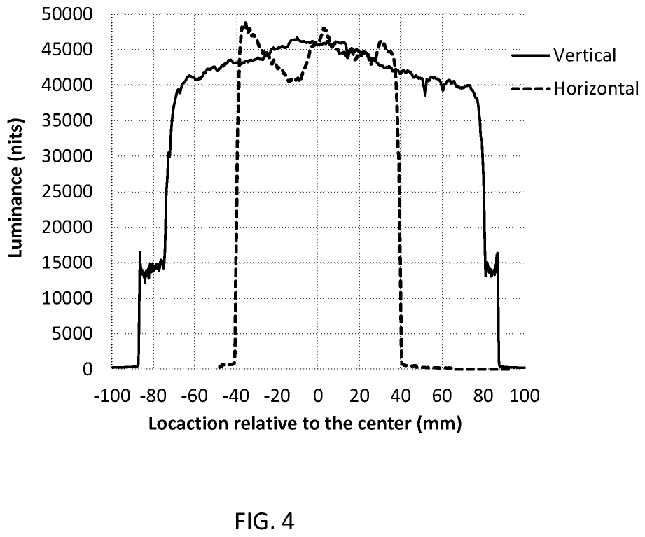

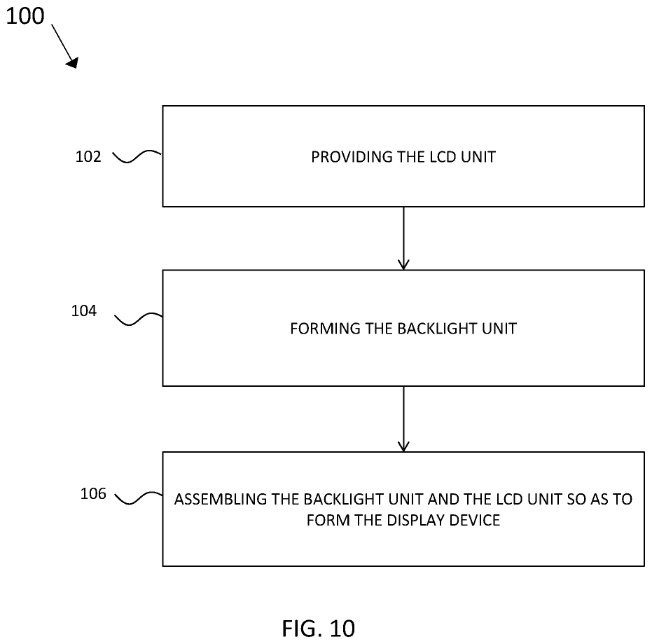

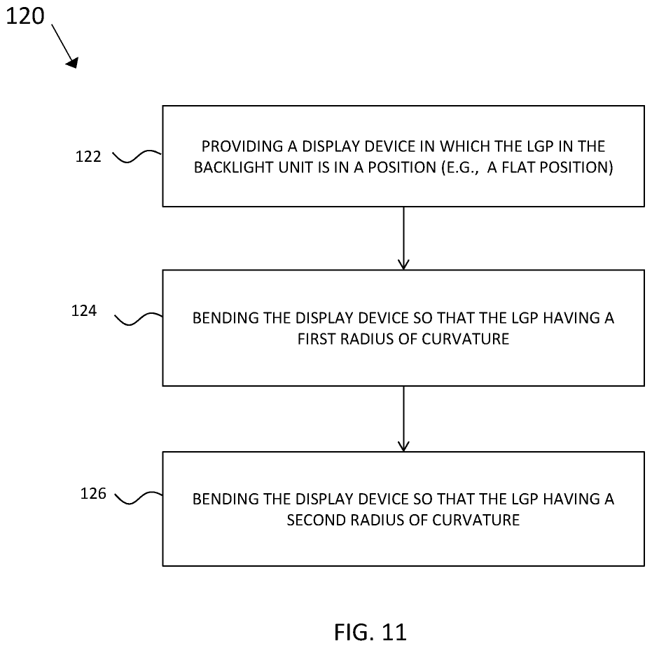

In FIGS. 1A-3, 5, and 8-9B, like items are indicated by like reference numerals, and for brevity, descriptions of the structure, provided above with reference to the preceding figures, are not repeated. FIGS. 4, 6, and 7 illustrates some performance of exemplary devices. The methods described in FIGS. 10-11 are described with reference to the exemplary structure described in 1A-3, 5, and 8-9B.

One aspect of this disclosure pertains to a backlight that provides high luminance that enables sunlight readability due to its high luminance, and is dynamically bendable, allowing the user to vary its curvature. In one or more embodiments, the backlight is also capable of local dimming for power saving and higher dynamic range.

Embodiments of the backlight may be used in an automotive display that forms part of an electronic component including, but are not limited to, an instrument cluster display, a center stack display, head-up display, rear seat entertainment display, and electronic-mirror display. In one or more embodiments, the backlight unit can conform to a variety of surface profiles, can be integrated with a flexible LCD and a flexible cover lens to form a flexible display module.

Referring to FIG. 1A, an exemplary display device 10 includes a dynamically bendable display 20 as highlighted in a dashed box, and a backlight 30. The bendable display 20, which includes a LCD display unit 50, may be a part of the center stack automotive display in some embodiments. On the front surface 16 of the exemplary display device 10, electronic buttons or controls 18 may be used to bent a portion or the whole display device 10, and/or select the desired information to be displayed. Depending on the user's selection by pressing a control 18, the bendable display 20 or the whole display device 10 can be bent in the length (or vertical) direction. In addition to a display unit (e.g., LCD, OLED and the like) and a backlight, such a display device requires a dynamically bendable cover substrate.

Referring to FIGS. 1B-1D, an exemplary display device 60 (or 62) comprises a backlight unit 30 and a LCD unit 50. The backlight unit 30 comprises a light guide plate (LGP) 32 and a light source 40. In some embodiments, the exemplary display device 60 (or 62) may include at least one dynamically bendable display 20, which is highlighted in the dashed line area for illustration purpose. The whole device might be dynamically bendable. The exemplary display device 60 illustrated in FIG. 1B and the exemplary display device 62 illustrated in FIG. 1C are the same, except the number and the location of the light source 40 as described herein.

The LGP 32 has a first major surface 32a, a second major surface 32b opposite to the first major surface 32a, and a first side wall surface 32c between the first major surface 32a and the second major surface 32b. The first light source 40 is in contact with or in proximity to the first wall surface 32c, and is optically coupled with the LGP 32.

Referring to FIG. 1B, in the exemplary display device 60, the first light source 40 may be also disposed along the width (or horizontal) direction of the LGP 32 in some embodiments. Referring to FIG. 1C, two light sources 40 are used. The LGP 32 further comprises a second side wall surface 32c opposite the first sidewall surface. The backlight unit 30 comprises a second light source 40 contacting or in proximity to the second side wall surface 32c and optically coupled with the LGP. Each light source 40 is disposed in contact with or adjacent to each of two opposite side wall surfaces 32c of the LGP 32. Each light source 40 is disposed along a direction of the length (i.e., the longer side) or a width direction of the GP 32 or the LCD screen or unit 50. The configurations in FIG. 1B and FIG. 1C may be used alone or in combination, depending on the size and the orientation of the LCD unit 50. Unless expressly indicated otherwise, the descriptions for the first light source 40 also apply to another light source such as the second or the third light source.

Light source 40 comprises light emitting diodes (LEDs), and may be a LED strip in some embodiments. Light source 40 may also comprises OLEDs and fluorescent light in some embodiments. Light source 40 may be mechanically coupled with or mounted onto the LGP 32, or bonded with the LGP 32, for example, using an inorganic or organic adhesive. For example, a polymer such as epoxy, silicone, or polyimide may be used for bonding light source 40 onto the LGP 32.

In some embodiments, the gap between light source 40 and the side wall surface 32c of the LGP 32 may be less than about 0.01 mm. The light source may directly contact the side wall surface of the LGP 32 in some embodiments. When LGP 32 is made of a thin strengthened glass, the LGP 32 can dissipate or withstand any possibly generated heat even when light source 40 is close to or in contact with the LGP 32. Thus the brightness of the LGP 32 is significantly improved.

Referring to FIG. 1D, the display device 60 or 62 further may comprise one or more components such as a light extractor 33, a reflector 31, a diffuser sheet 34, at least one prismatic film 36, a touch panel 52, a cover lens 54, and any combination thereof. A light extractor having good transparency and a patterned microstructure may be optionally coated or printed on the first and/or second major surface of the LGP 32 to improve light uniformity. In some embodiments, the LGP 32 is one layer only without other coating. As illustrated in FIG. 1D, the reflector (or bottom reflector) 31 may be disposed below the LGP 32 to reflect light back toward to the LGP 32. The diffuser sheet 34 and the at least one prismatic film 36 (e.g., two prismatic films 36a, 36 b) may be disposed above the LGP 32 and below the display unit 50 (e.g., LCD). The touch panel 52 may be disposed above the display unit 50. The cover lens 54 is disposed above the tough panel 52. These components illustrated in FIG. 1D may be stacked up together, with or without contacting with one another. In other embodiments, the LGP 32 has an additional layer over which the light extractor 33 is made. The additional layer may provide benefits such as improved adhesion between the light extractor 33 and the LGP 32.

The light guide plate (LGP) 32 may comprise or is made of a material selected from the group consisting of a glass, a polymer, and a combination thereof. The LGP 32 is transparent with high light transmittance, and may be configured for both flexible and rigid displays.

In some embodiments, the LGP 32 comprises or is made of a strengthened glass. Such a glass is strengthened chemically through ion exchange, thermally, or both chemically and thermally. The LGP 32 has a thickness in a range of from about 0.01 mm to about 6 mm, for example, from about 0.01 mm to about 0.7 mm, or from about 0.01 mm to about 1.6 mm, or any other suitable range. The LGP 32 is configured to be dynamically bendable to a minimum radius of curvature of about 100 mm. The maximum radium of curvature can be infinity when the LGP is flat. In some embodiments, its radius of curvature can be in a range of from about 100 mm to about 1,000 mm, for example, from about 100 mm to about 400 mm, from about 200 mm to about 400 mm, or any other suitable ranges.

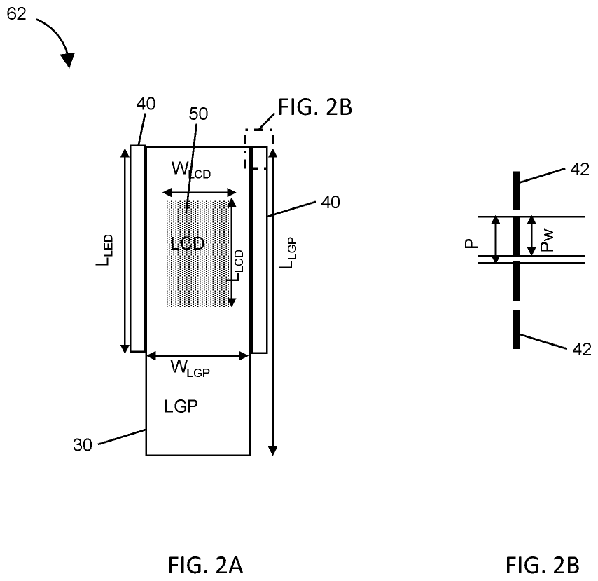

Referring to FIG. 2A, in some embodiments, the LGP 32 has a dimension such as length greater than a dimension such as length for the LCD unit. The dimension or size of the LCD unit may be pre-determined. For example, a ratio of the length of the LGP 32 to the length of the LCD unit 50 is 1.2 or higher. Examples of a range for such as ratio include, but not limited to 1.2-3, 2-3, 3-5, or any suitable range. The LGP 32 may have a size much larger than that of one LCD unit 50. The LGP can be used to illuminate two or more LCD units in some embodiments. The light source 40 has a dimension such as length equal to or greater than the dimension such as length for the LCD unit. In some embodiments, the length of the LGP 32 may be greater than the length of the light source 40. In some embodiments, the LGP 32 is shaped and sized to illuminate one or more additional LCD units. The length of the LGP 32 may be much greater than the length of the light source 40.

These dimension relationship applies to both flexible backlights and rigid backlights. In some embodiments, the LGP 32 is made of any glass having thin strengthened glass as described for flexible backlight, or has any suitable thickness for rigid display applications. In some embodiments, the LGP 32 is made of a polymer having a suitable thickness for both flexible and rigid display application.

FIG. 2A shows the definitions of various dimensions including the length of the LEDs being L_{LED}, the length and width of the LGP being L_{LGP} and W_{LGP}, the length and width of the LCD being L_{LCD} and W_{LCD}, and the LED package width and LED pitch being Pw and P, respectively. In a comparative backlight in some embodiments, the LGP is only slightly larger than the corresponding display in both length and width, for example, just a few millimeters larger to allow LED light to be uniformly mixed. Reflective tapes can be optionally applied to the edges of the LGP where LEDs are not adjacent. In the backlight shown in FIG. 2A, the LGP can be significantly larger than the LCD, allowing multiple displays to be illuminated by a single piece of LGP. For example, L_{LGP}/L_{LED} 2.9. The length of the LEDs can be equal to or larger than the length of the LCD, that is L_{LED}/L_{LCD}>1.

Referring to FIG. 2B, in some embodiments, each light source 40 comprises a plurality of light emitting diodes (LEDs). Each LED has a length (Pw). The plurality of LEDs are disposed in a repeating pattern with a pitch (P). The ratio of Pw/P may be in a range of from 0.5 to 0.95 (e.g., from 0.75 to 0.86). The pitch (P) includes the length of one LED and the gap between two adjacent LEDs.

The choice of the glass article for the LGP drives the dynamic bendability of the backlight 30. For example, in one or more embodiments, the thickness of the glass article for the LGP 32 permits dynamic bending of the LGP from a first radius of curvature to a second radius of curvature that is from about 100 mm or greater (e.g., about 100 mm to about 10000 mm, about 100 mm to about 5000 mm, about 100 mm to about 4000 mm, about 100 mm to about 3000 mm, about 100 mm to about 2000 mm, about 100 mm to about 1000 mm, from about 100 mm to about 1500 mm, about 100 mm to about 1000 mm, from about 100 mm to about 1250 mm, from about 100 mm to about 1000 mm, from about 100 mm to about 750 mm, from about 100 mm to about 500 mm, from about 100 mm to about 250 mm, from about 100 mm to about 200 mm, from about 150 mm to about 1500 mm, from about 200 mm to about 1500 mm, about 1000 mm to about 400 mm, about 200 mm to about 400 mm, from about 300 mm to about 1500 mm, from about 400 mm to about 1500 mm, from about 500 mm to about 1500 mm, from about 750 mm to about 1500 mm, from about 1000 mm to about 1500 mm, from about 1250 mm to about 1500 mm). In one or more embodiments, the thickness of the glass article permits effective optical coupling with a light source.

Exemplary glasses can include, but are not limited to, aluminosilicate, alkali-aluminosilicate, borosilicate, alkali-borosilicate, aluminoborosilicate, alkali-aluminoborosilicate, and other suitable glasses.

In one or more embodiments, the glass article for the LGP 32 is strengthened. In one or more embodiments, the glass article may be strengthened mechanically by utilizing a mismatch of the coefficient of thermal expansion between portions of the article to create a compressive stress region and a central region exhibiting a tensile stress. In some embodiments, the glass article may be strengthened thermally by heating the glass to a temperature above the glass transition point and then rapidly quenching.

In one or more embodiments, the glass article for the LGP 32 may be chemically strengthening by ion exchange. In the ion exchange process, ions at or near the surface of the glass article are replaced by—or exchanged with—larger ions having the same valence or oxidation state. In those embodiments in which the glass article comprises an alkali aluminosilicate glass, ions in the surface layer of the article and the larger ions are monovalent alkali metal cations, such as Li+, Na+, K+, Rb+, and Cs+. Alternatively, monovalent cations in the surface layer may be replaced with monovalent cations other than alkali metal cations, such as Ag+ or the like. In such embodiments, the monovalent ions (or cations) exchanged into the glass article generate a stress.

Ion exchange processes can be carried out by immersing a glass article in one or more molten salt baths containing the larger ions to be exchanged with the smaller ions in the glass article. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the glass article in a salt bath (or baths), use of multiple salt baths, additional steps such as annealing, washing, and the like, are generally determined by the composition of the glass article (including the structure of the article and any crystalline phases present) and the desired CS, DOC and CT values of the glass article that results from strengthening. Exemplary molten bath composition may include nitrates, sulfates, and chlorides of the larger alkali metal ion. Typical nitrates include KNO3, NaNO3, LiNO3, NaSO4 and combinations thereof. The temperature of the molten salt bath typically is in a range from about 380° C. up to about 450° C., while immersion times range from about 15 minutes up to about 100 hours depending on glass article thickness, bath temperature and glass (or monovalent ion) diffusivity. However, temperatures and immersion times different from those described above may also be used.

In one or more embodiments, the glass articles for the LGP 32 may be immersed in a molten salt bath of 100% NaNO₃, 100% KNO₃, or a combination of NaNO₃ and KNO₃ having a temperature from about 370° C. to about 480° C. In some embodiments, the glass article may be immersed in a molten mixed salt bath including from about 1% to about 99% KNO₃ and from about 1% to about 99% NaNO₃. In one or more embodiments, the glass article may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass article may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less. In one or more embodiments, the glass article is immersed in a first mixed molten salt bath (e.g., 75% KNO₃/25% NaNO₃) having a temperature of 430° C. for 8 hours, and then immersed in a second pure molten salt bath of KNO₃ having a lower temperature than the first mixed molten salt bath for a shorter duration (e.g., about 4 hours).

Ion exchange conditions can be tailored to provide a “spike” or to increase the slope of the stress profile at or near the surface of the resulting glass article. The spike may result in a greater surface CS value. This spike can be achieved by single bath or multiple baths, with the bath(s) having a single composition or mixed composition, due to the unique properties of the glass compositions used in the glass articles described herein.

In one or more embodiments, where more than one monovalent ion is exchanged into the glass article, the different monovalent ions may exchange to different depths within the glass article (and generate different magnitudes stresses within the glass article at different depths). The resulting relative depths of the stress-generating ions can be determined and cause different characteristics of the stress profile.

In one or more embodiments, the glass article has a surface CS in a range from about 200 MPa to about 1000 MPa (e.g., from about 300 MPa to about 1000 MPa, from about 400 MPa to about 1000 MPa, from about 500 MPa to about 1000 MPa, from about 600 MPa to about 1000 MPa, from about 700 MPa to about 1000 MPa, from about 800 MPa to about 1000 MPa, from about 300 MPa to about 900 MPa, from about 300 MPa to about 800 MPa, from about 300 MPa to about 700 MPa, from about 300 MPa to about 600 MPa, from about 300 MPa to about 500 MPa, or from about 300 MPa to about 400 MPa). The foregoing CS values may be measured at a major surface or may be found at a depth from the major surface within the CS region.

In one or more embodiments, the CTₘₐₓ magnitude is about 80 MPa or less, about 78 MPa or less, about 76 MPa or less, about 75 MPa or less, about 74 MPa or less, about 72 MPa or less, about 70 MPa or less, about 68 MPa or less, about 66 MPa or less, about 65 MPa or less, about 64 MPa or less, about 62 MPa or less, about 60 MPa or less, about 58 MPa or less, about 56 MPa or less, about 55 MPa or less, about 54 MPa or less, about 52 MPa or less, or about 50 MPa or less. In one or more embodiments, the CTₘₐₓ magnitude is in a range from about 40 MPa to about 80 MPa, from about 45 MPa to about 80 MPa, from about 50 MPa to about 80 MPa, from about 55 MPa to about 80 MPa, from about 60 MPa to about 80 MPa, from about 65 MPa to about 80 MPa, from about 70 MPa to about 80 MPa, from about 40 MPa to about 75 MPa, from about 40 MPa to about 70 MPa, from about 40 MPa to about 65 MPa, from about 40 MPa to about 60 MPa, from about 40 MPa to about 55 MPa, or from about 40 MPa to about 50 MPa. In one or more embodiments, the foregoing ranges the magnitude of CTmax is present when the glass article is in a substantially flat configuration (e.g., the glass article has a radius of curvature of greater than about 5000 mm, or greater than about 10,000 mm).

In one or more embodiments, the glass article of the LGP 32 may have a thickness of about 0.6 mm or less (e.g., from about 0.1 mm to about 0.6 mm, from about 0.2 mm to about 0.6 mm, from about 0.25 mm to about 0.6 mm, from about 0.3 mm to about 0.6 mm, from about 0.4 mm to about 0.6 mm, from about 0.5 mm to about 0.6 mm, from about 0.1 mm to about 0.55 mm, from about 0.1 mm to about 0.5 mm, from about 0.1 mm to about 0.4 mm, or from about 0.1 mm to about 0.3 mm). In one or more embodiments, the glass article has a thickness of about 0.55 mm.

In one or more embodiments, the glass article of the LGP 32 includes light extractors disposed on the glass article to extract light and meet targeted uniformity.

In one example, the light emitted from the light source 40 or the plurality of light sources 42 is coupled into the LGP 32. In one or more embodiments, the light source 40 or the plurality of light sources 42 comprises LEDs. In one or more embodiments, the light source 40 or the plurality of light sources 40 each emitting about 18 lumens at a current of 20 mA, with emission height of about 0.46 mm. Its maximum current is 30 mA. Thus most of the light emitted from the light source 40 or the plurality of light sources 42 can be coupled into the glass article of the LGP, given that the gap between the light source 40 and the LGP 32 can be made as small as practically possible. For example, the gap can be 0.01 mm or smaller because the glass LGP, unlike a plastic LGP, does not experience any warpage caused by high temperature and/or high humidity. LEDs emitting 9 lumens or more at a current of 20 mA can also be used.

A strengthened glass is better than soda lime glass as flexible light guide plate. Based on the 4-point bend testing following ASTM standard C-158 for 1.1 mm thick soda lime glass and 1.1 mm thick strengthened glass IOX-GG with the same edge finish. The bending strength for soda lime glass is 90.6 MPa, based on which its calculated bending radius or radius curvature is about 420 mm. For the strengthened glass IOX-GG, the bending strength was 707 MPa, based on which its calculated bending radius or radius curvature is about 54 mm. A strengthened glass can be bent with a radius of curvature to 100 mm or higher.

In some embodiments, the LGP 32 is made of at least one polymer. Examples of a suitable polymer material include, but are not limited to, cyclic olefin co-polymers, polyester, polyacrylate such as polymethylmethacrylate (PMMA), polycarbonate (PC), polyimide, silicone, fluorosilicone, amorphous fluoropolymer, any other suitable polymers, and any combination thereof. Examples of a polyester include, but are not limited to, polyethylene naphthalate (PEN), polyethylene terephthalate (PET), and any combination thereof. In some embodiments, the LGP 32 may include a combination of glass and at least one polymer. For example, the at least one polymer may be coated onto a surface of a glass based LGP, or may be formed in a pattern as light extractors.

In accordance with some embodiments, the display device 60 or 62 as described includes a LGP made of glass, and may be configured for curved or flexible display applications in any suitable field such as automotive display application. In some embodiments, such a device comprises at least one LCD unit 50 and a backlight unit 30. The backlight unit 30 includes a LGP 32 and a first light source 40. The LGP 32 has a first side wall 32c between the first and the second major surfaces 32a and 32b. The first light source 40 contacts or is in proximity to the first side wall surface 32c. The LGP 32 has a dimension such as length greater than a dimension such as length of the at least one LCD unit 50. Light source 40 has a dimension such as length equal to or greater than that of the at least LCD unit 50. The LGP 32 is made of glass, and may have a thickness in a range of from about 0.01 mm to about 0.7 mm. The LGP 32 is configured to be dynamically bendable to a minimum radius of curvature of about 100 mm, and a maximum radius of curvature of infinity. In some embodiments, its radius of curvature can be in a range of from 100 mm to 1,000 mm. In some embodiments, the LGP 32 further comprises a second side wall surface 32c, and the backlight unit 30 comprises a second light source 40 contacting or in proximity to the second side wall surface and optically coupled with the LGP 32. The first and the second side wall surfaces 32c are opposite to each other.

In some embodiments, each light source 40 comprises a plurality of discrete LED 42 disposed in a repeating patter with a pitch (P) at a ratio of Pw/P in a range of from 0.5 to 0.95 (e.g., from 0.7 to 0.86), where Pw is a length of each LED. In some embodiments, the ratio Pw/P can be in a range of from 0.6 to 0.95. In some embodiments, the ratio of Pw/P is preferred to be as close to 1 as practically possible to provide higher optical flux. In other embodiments, the ratio of Pw/P can be as small as 0.6 when enough optical flux is available for some applications.

The backlight unit 30 and the resulting display device 62 as described herein have high luminance. For example, in some embodiments, the backlight unit 30 has a luminance in a range of from about 15,000 nits to about 68,000 nits, and the exemplary display device 62 has a luminance in a range of from about 1,000 nits to about 4,700 nits, at a current in a range of from about 10 mA to 30 mA at an ambient temperature of 25° C.

Without being bound by any particular theory, at least several factors contribute to the high luminance of the backlight unit 30 and the resulting display device 62 in some embodiments. These factors include: (1) chemical compositions, structures and mechanical strength of the LGP 32 as described herein, for example, the LGP comprising a strengthened glass; (2) thickness of the LGP 32 as described herein, for example, a thickness range of glass based LGP; (3) heat tolerance or heat mitigation property of the LGP 32 such as glass based LGO as described herein; (4) relative size and dimensions of the component such as the LGP 30, the light sources 40 and the display unit 50 as described herein; and (5) the ratio of pitch dimension to individual light source dimension as described herein. These factors are not exhaustive, and may be utilized alone or in any combination.

### Examples and Performance

Referring to FIGS. 1C-1D and 2A-2B, a prototype of a bendable backlight 30 having glass based LGP 32 was made. Such backlight provide high brightness and dynamical bendability. The glass LGP based backlight includes two key components: a flexible glass article that forms a LGP 32 with light extractors and two light sources 40 such as LEDs having high brightness. Each light source 40 is disposed on each side of the length direction of the LGP 32. Light from the LEDs as the light sources 40 is edge-coupled into the LGP 32 and subsequently extracted out. The backlight 30 also includes a bottom reflector 31 under the LGP 32, and a diffuser sheet 34 and two prismatic films 36 above the LGP, as illustrated in FIG. 1D.

The choice of the glass for the LGP is important. The thickness of the glass needs to be small enough to allow a radius of curvature of 200 mm or 100 mm and large enough to effectively couple LED light in. Strengthened glass helps sustain the dynamic bending. In the prototypes, the glass LGP is made of strengthened glass having a thickness of 0.55 mm. This glass is designed with improved native damage resistance with enhances retained strength after use, high edge strength, high surface resistance to scratch and sharp contact damage, and superior surface quality. The glass can be bendable to a radius of 200 mm. The finishing of the glass LGP edge is also important. It is important to polish the four side walls to remove defects created during the glass cutting. In one embodiment, the side walls are polished to be straight or flat; flat side walls are advantageous in light coupling efficiency. In another embodiment, the side walls are polished to be rounded; rounded side walls are advantageous in mechanical strength.

Light extractors 33 are printed on the glass LGP to extract light and meet targeted uniformity. For the LEDs used as the light sources, each LED emits about 18 lumens at a current of 20 mA, with emission height of about 0.46 mm. Its maximum current is 30 mA. Thus most of the light emitted from the LED can be coupled into the 0.55 mm thick glass LGP, given that the gap between the LEDs and the LGP can be made as small as practically possible. The gap can be 0.01 mm or smaller because the glass LGP, unlike a plastic LGP, does not experience any warpage caused by high temperature and/or high humidity. Light extractors 33 are inkjet printed with a white ink, such as LH-100 UV curable white ink available from Mimaki. Other suitable materials can also be used. And other suitable fabrication methods such as screening printing may also be used to make the light extractors.

The LED bar is designed to provide a high luminance for a target display. The ratio L_{LED}/L_{LCD}≈1.93. Table 1 summarizes the dimensions of the backlight.

TABLE 1

| | W_{LGP} | L_{LGP} | L_{LED} | W_{LCD} | L_{LCD} | Pw | P |
|---|---|---|---|---|---|---|---|
| Unit: | 150 | 440 | 294 | 152.4 | 91.44 | 4.2 | 4.9 |
| mm | | | | | | | |

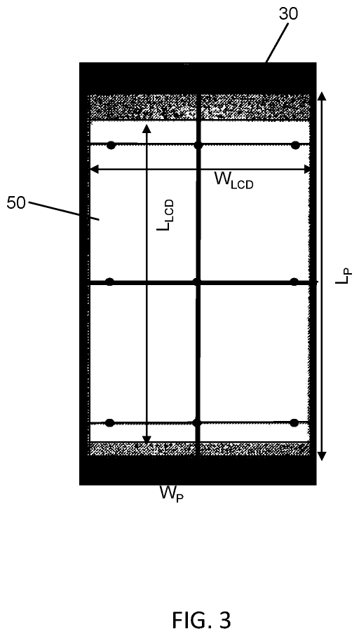

The backlight uniformity and luminance of the prototype backlight were measured. FIG. 3 shows the photograph of the prototype backlight when it is flat. Both sets of LEDs are turned on. The length and width of the light extraction pattern, Lₚ and Wₚ, are slightly larger than those of the LCD, respectively. The light extraction pattern refers to the pattern of the light extractors, in which the density of the light extractors varies. In particular, the density of the light extractors increases with the distance measured from the LEDs. The maximum area density of the light extractors occurs at the middle of the pattern, which is between 70% to 100%. The area density of the light extractors is defined as a ratio of the area of the square that encloses the light extractor over a selected area. The photograph was taken with Radiant's ProMetric Imaging Colorimeter (Model IC-PMI16). According to the 9-point luminance map (with end points being 10% from the edges of the LCD), the luminance uniformity, defined as Lₘᵢₙ/Lₘₐₓ, is about 81%. The black area in the horizontal direction hides the LEDs; the black area in the vertical direction blocks the residual light that is not needed for the illumination of the LCD.

FIG. 4 shows the spatial luminance distribution of the backlight along the central vertical and horizontal directions shown in FIG. 3. The center luminance of the backlight reaches about 46000 nits with each LED current I≈20.0 mA. When a commercial 7″ LCD (normally white LCD with a reflective polarizer on the rear glass substrate) is placed over the backlight, the display luminance is measured at about 3100 nits. The luminance is measured with Radiant's ProMetric Imaging Colorimeter (Model IC-PMI16). It can also be measured with any other luminance meter, such as PR-680 spectroradiometer from Photo Research.

Table 2 summarizes the center luminance values for the backlight (“Backlight Luminance”) and the backlight with the LCD (“Display Luminance”). The values in bold are measured; while the others are calculated, on the assumptions of linear relationships between the luminance and the current, and between the backlight luminance and the display luminance. The transmittance of the LCD used in the prototype is measured to be about 6.8%.

In the case of L_{LED}/L_{LCD}≈1.00, the extra LEDs that do not directly illuminate the LCD were blocked. The display luminance is expected to be about 2000 nits at a current of 20 mA. With the increase in the ratio L_{LED}/L_{LCD}, the display luminance increases. However the display luminance increases at a lower rate than the ratio L_{LED}/L_{LCD}, indicating that the light loss occurs when the LEDs do not directly illuminate the active area of the LCD.

The luminance values achieved with the prototype backlight are about two to three times of 1000 nits reported for automotive display demos shown at the display week 2018 exhibits.

TABLE 2

| | L_{LED}/L_{LCD} ≈ 1.93 | | L_{LED}/L_{LCD} ≈ 1.00 | |
|---|---|---|---|---|
| | Display | Backlight | Display | Backlight |
| | Luminance | Luminance | Luminance | Luminance |
| I (mA) | (nits) | (nits) | (nits) | (nits) |
| 16.4 | 2550 | 36600 | 1661 | 24384 |
| 20.0 | 3130 | 45960 | 2025 | 29737 |
| 25 | 3887 | 57078 | 2531 | 37171 |
| 30 | 4665 | 68494 | 3038 | 44605 |

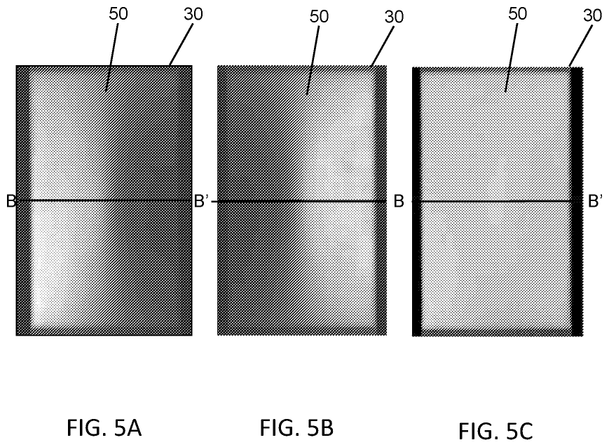

The prototype backlight also possesses local dimming capability. FIG. 5A-5C are the photographs of the prototype backlight under three conditions: with the left set of LEDs on (FIG. 5A), with the right set of LEDs on (FIG. 5B), and with both sets of LEDs on (FIG. 5C), respectively. They are taken with L_{LED}/L_{LCD}≈1.93 at a current I=16.4 mA.

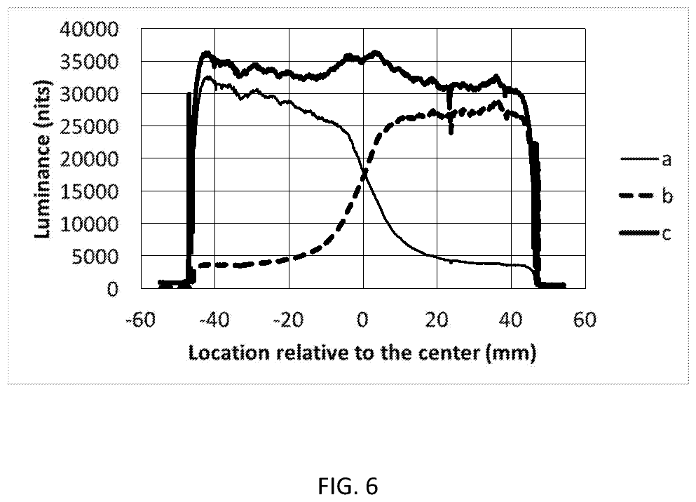

FIG. 6 shows the spatial luminance distributions along the center horizontal lines (B-B′) shown in FIG. 5A-5C under three conditions: (a) with the left set of LEDs on; (b) with the right set of LEDs on; and (c) with both sets of LEDs on. The degree of the local dimming was measured by a local dimming index defined as LDI=1−Average luminance in non-illuminated zone/Average luminance in illuminated zone. For example, based on Curve (a) of FIG. 6, LDI=1−Average luminance for location between −45 mm and 0 mm/Average luminance for location between 0 mm and 45 mm. Based on Curve (b), LDI=1 Average luminance for location between 0 mm and 45 mm/Average luminance for location between −45 mm and 0 mm. In either case, the LDI≈78%.

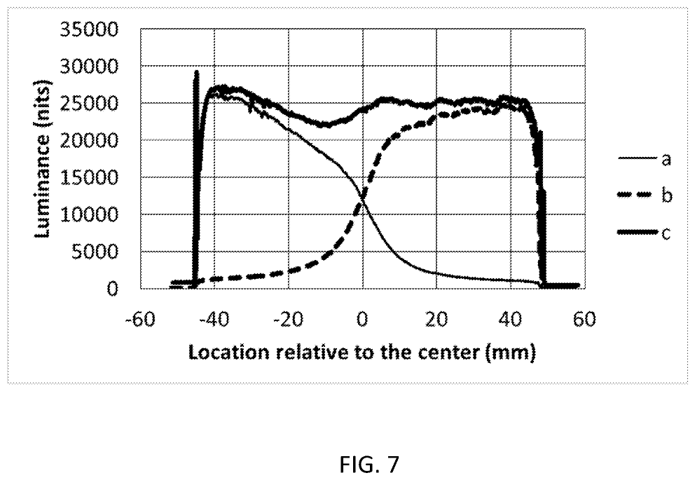

In the case of L_{LED}/L_{LCD}≈1.00, the extra LEDs that do not directly illuminate the LCD were blocked. Similar to FIG. 6, FIG. 7 shows the spatial luminance distributions along the center horizontal lines in the three conditions. The luminance level drops more rapidly in a non-illuminated zone. The local dimming index increases to about 85%. This LDI is comparable to or above the typical value of 74%-83% from an edge-lit backlight using lenticular lenses.

In the prototype, the LEDs on the same set are wired to the same power source, thus each LED cannot be individually switched on or off. However, it is conceivable that once each LED or a subset of the LEDs is separately switchable, a two-dimensional local dimming can be realized. Additionally a plurality of lenticular lens known in the art can be added to the top or bottom surface of the LGP to enhance the collimation and thus local dimming.

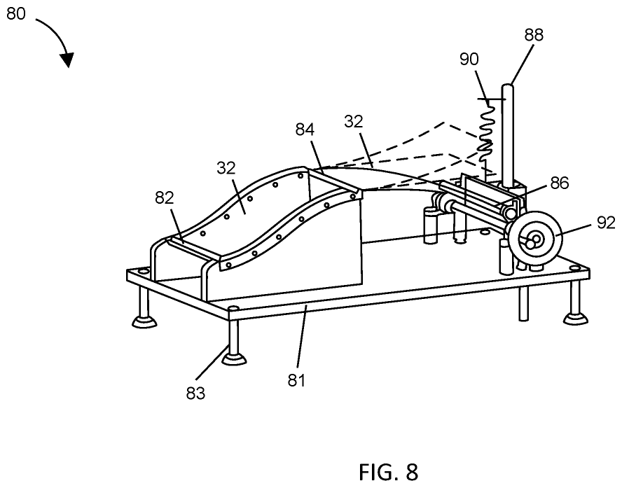

FIG. 8 shows an exemplary fixture 80 that allows dynamically bending the glass LGP, the entire backlight, the LCD, and the cover substrate. The curvature of the glass LGP or the entire backlight can vary from concave to flat to convex. The fixture 80 includes a base 81 with base supports 83. The fixture 80 further includes supports for the glass LGP 32, including a first support 82 for holding one end of the LGP 32, and a second support 84 for supporting the middle portion of the glass LGP 32. A glass holder 86 is used for holding and moving the other end of the glass LGP 32 along a beam 88. A component such as a spring 90 component such as a spring 90 on the top of glass holder 86 allows a convex shape of the glass LGP 32. Another component such as a spring 90 on the bottom of glass holder allows a concave shape of the glass LGP 32. The fixture 80 may also include a rotating wheel or other means 92 configured to move the glass holder 86 along the beam 88.

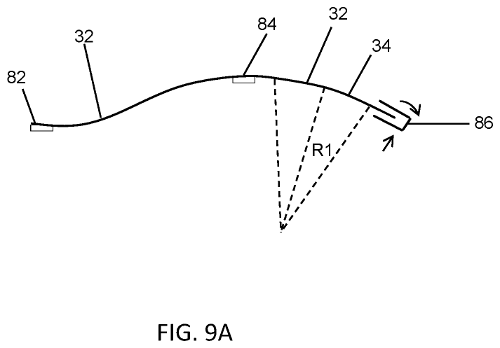

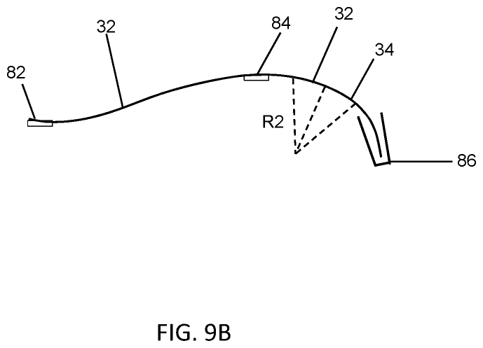

FIGS. 9A-9B are sectional views illustrating how the glass LGP 32 can be bent by using the fixture 80. The two supports 82, 84 are used to maintain glass in a predetermined shape at the end of the dynamically bendable and curved area. According to one example, in the glass width direction (horizontal), the width of the two supports 82, 84 is great than 0.25″. Each of the two supports 82, 84 and the glass LGP 32 can be bonded together by any suitable adhesive. Glass holder 86 is designed for providing the moment at the glass edge so that the glass LGP can have a uniform radius from support 84 to glass holder 86. The spring stiffness is as a function of glass dimensions. A dynamic bendable mechanical fixture design with a controllable uniform curved shape can meet with customer equipment and avoid optical distortion.

Referring to FIGS. 9A-9B, the glass LGP 32 or the resulting backlight 30 can be positioned in a first position, in which the glass LGP 32 or the backlight 30 has a first radius of curvature, for example, R1 as illustrated in FIG. 9A. The glass LGP 32 or the backlight 30 may be bent or dynamically bent in which the glass LGP 32 or the backlight 30 is curved into a second position, in which the backlight has a second radius of curvature, for example, R2 as illustrated in FIG. 9B. R2 may be less than R1. Referring to FIG. 9B, in some embodiments, the glass holder 86 has an increased length to allow tighter bending with a smaller radius of curvature.

The present disclosure also provides a method of making the backlight unit or a method of making the display device as described herein. Referring to FIG. 10, an exemplary method 100 is used to make a display device. At step 102, the LCD unit 50 is provided. At step 104, the backlight unit 30 is formed by using the LGP 32, the light sources 40, and other components as described herein. At step 106, the backlight unit 30 and the LCD unit 50 are assembled so as to form the display device. Other components such as a touch panel 52 and a cover lens 54 may be also placed above the LCD unit 50.

The present disclosure also provides a method of using the backlight unit or a method of using the display device as described herein. Referring to FIG. 11, an exemplary method 120 is illustrated. The display device may be bent so that the LGP 32 in the backlight unit 30 is bent from a flat position or from a first radius of curvature to a second radius of curvature. For example, at step 122, an exemplary display device 62 may be provided in a first position, in which the LGP 32 is flat. At step 124, the exemplary display device 62 is bent so that the LGP 32 has a first radius of curvature (R1, FIG. 9A). At step 126, the exemplary display device 62 is further bent so that the LGP 32 has a second radius of curvature (R2, FIG. 9B). The LGP 32 may be in a concave or convex position. One of the first or the second radius of curvature may be in a range of from about 100 mm to about 1,000 mm (e.g., 100-400 mm, 200-400 mm, 100-500 mm, or 200-500 mm).

While the inventive backlight is described to illuminate a LCD, the backlight can also be used as a standalone high brightness lighting unit, in the absence of the LCD. In some embodiments, the lighting unit is conformable to a curved surface. The lighting unit has the features as for the backlight as described above. For brevity, descriptions of the structure, provided above with reference to the backlight unit, are not repeated.

Aspect (1) of this disclosure pertains to a backlight unit for a liquid crystal display (LCD) unit in a display device, comprising: a light guide plate having a first major surface, a second major surface opposite to the first major surface, and a first side wall surface between the first major surface and the second major surface; and a first light source contacting or in proximity to the first side wall surface and optically coupled with the light guide plate, wherein the light guide plate has a length greater than a pre-determined length for the LCD unit, and the first light source has a length equal to or greater than the pre-determined length for the LCD unit.

Aspect (2) pertains to the backlight unit of Aspect (1), wherein the length of the light guide plate is greater than the length of the first light source.

Aspect (3) pertains to the backlight unit of Aspect (1) or Aspect (2), wherein a ratio of the length of the light guide plate to the length of the LCD unit is 1.2 or higher.

Aspect (4) pertains to the backlight unit of any one of Aspects (1) through (3), wherein the light guide plate comprises a material selected from the group consisting of a glass, a polymer, and a combination thereof.

Aspect (5) pertains to the backlight unit of any one of Aspects (1) through (4), wherein the light guide plate comprises a chemically or thermally strengthened glass.

Aspect (6) pertains to the backlight unit of Aspect (5), wherein the light guide plate has a thickness in a range of from about 0.01 mm to about 6 mm.

Aspect (7) pertains to the backlight unit of Aspect (5), wherein the light guide plate has a thickness in a range of from about 0.01 mm to about 0.7 mm.

Aspect (8) pertains to the backlight unit of any one of Aspects (5) through (7), wherein the light guide plate is configured to be dynamically bendable to a minimum radius of curvature of about 100 mm.

Aspect (9) pertains to the backlight unit of any one of Aspects (1) through (8), wherein the light guide plate further comprises a second side wall surface opposite the first sidewall surface, and the backlight unit comprises a second light source contacting or in proximity to the second side wall surface and optically coupled with the light guide plate.

Aspect (10) pertains to the backlight unit of any one of Aspects (1) through (9), wherein the first light source comprises a plurality of discrete LEDs.

Aspect (11) pertains to the backlight unit of Aspect (10), wherein each discrete LED has a length (Pw), and the plurality of discrete LEDs are disposed in a repeating pattern with a pitch (P) at a ratio of Pw/P in a range of from 0.5 to 0.95.

Aspect (12) pertains to a display device comprising: a liquid crystal display (LCD) unit; and a backlight unit, comprising: a light guide plate having a first major surface, a second major surface opposite to the first major surface, and a first side wall surface between the first major surface and the second major surface; and a first light source contacting or in proximity to the first side wall surface and optically coupled with the light guide plate, wherein the light guide plate has a length greater than a length of the LCD unit, and the first light source has a length equal to or greater than the length of the LCD unit.

Aspect (13) pertains to the display device of Aspect (12), wherein the length of the light guide plate is greater than the length of the first light source.

Aspect (14) pertains to the display device of Aspect (12) or (13), wherein the light guide plate is configured to illuminate one or more additional LCD units.

Aspect (15) pertains to the display device of any one of Aspects (12) through (14), wherein the light guide plate comprises a material selected from the group consisting of a glass, a polymer, and a combination thereof.

Aspect (16) pertains to the display device of any one of Aspects (12) through (15), wherein the light guide plate comprises a chemically or thermally strengthened glass.

Aspect (17) pertains to the display device of Aspect (16), wherein the light guide plate has a thickness in a range of from about 0.01 mm to about 0.7 mm, and is configured to be dynamically bendable to a minimum radius of curvature of 100 mm.

Aspect (18) pertains to the display device of Aspect (16) or (17), wherein a gap between the first light source and the first side wall surface is less than about 0.01 mm.

Aspect (19) pertains to the display device of any one of Aspects (12) through (18), wherein the first light source comprises a plurality of discrete LEDs.

Aspect (20) pertains to the display device of Aspect (19), wherein each discrete LED has a length (Pw), and the plurality of discrete LEDs are disposed in a repeating pattern with a pitch (P) at a ratio of Pw/P in a range of from 0.5 to 0.95.

Aspect (21) pertains to the display device of any one of Aspects (12) through (20), further comprising one or more components selected from the group consisting of a light extractor, a reflector, at least one prismatic film, a touch panel, a cover lens, and combinations thereof.

Aspect (22) pertains to a method of making the display device of any one of Aspects (12) through (21) comprising: providing the LCD unit; forming the backlight unit; and assembling the backlight unit and the LCD unit so as to form the display device.

Aspect (23) pertains to the method of using the display device of any one of Aspects (12) through (21), comprising: bending the display device so that the light guide plate in the backlight unit is bent from a flat position or from a first radius of curvature to a second radius of curvature.

Aspect (24) pertains to the method of using the display device of any one of Aspect (23) wherein one of the first or the second radius of curvature is in a range of from about 100 mm to about 10,000 mm.

Aspect (25) pertains to a display device, comprising: at least one liquid crystal display (LCD) unit; and a backlight unit, comprising: a light guide plate having a first major surface, a second major surface opposite to the first major surface, a first side wall surface between the first major surface and the second major surface; and a first light source contacting or in proximity to the first side wall surface and optically coupled with the light guide plate, wherein the light guide plate has a length greater than a length of the at least one LCD unit, and the first light source has a length equal to or greater than the length of the at least one LCD unit; and the light guide plate comprises glass having a thickness in a range of from about 0.01 mm to about 0.7 mm, wherein the light guide plate is configured to be dynamically bendable to a minimum radius of curvature in a range of 100 mm.

Aspect (26) pertains to the display device of Aspect (25), wherein the light guide plate further comprises a second side wall surface opposite the first sidewall surface, and the backlight unit comprises a second light source contacting or in proximity to the second side wall surface and optically coupled with the light guide plate.

Aspect (27) pertains to the display device of Aspect (26), wherein each of the first and the second light sources comprises a plurality of discrete LEDs, each discrete LED has a length (Pw), and the plurality of discrete LEDs are disposed in a repeating pattern with a pitch (P) at a ratio of Pw/P in a range of from 0.75 to 0.86.

Aspect (28) pertains to the display device of any one of Aspects (25) through (27), wherein the backlight unit has a luminance in a range of from about 15,000 nits to about 68,000 nits, and the display device has a luminance in a range of from about 1,000 nits to about 4,700 nits, at a current in a range of from about 10 mA to 30 mA.

Although the subject matter has been described in terms of exemplary embodiments, it is not limited thereto. Rather, the appended claims should be construed broadly, to include other variants and embodiments, which may be made by those skilled in the art.

1. A backlight unit for a liquid crystal display (LCD) unit in a display device, comprising:
a light guide plate having a first major surface, a second major surface opposite to the first major surface, and a first side wall surface between the first major surface and the second major surface; and
a first light source contacting or in proximity to the first side wall surface and optically coupled with the light guide plate,
wherein the light guide plate has a length greater than a pre-determined length for the LCD unit, and the first light source has a length equal to or greater than the pre-determined length for the LCD unit.

2. The backlight unit of claim 1, wherein the length of the light guide plate is greater than the length of the first light source.

3. The backlight unit of claim 1, wherein a ratio of the length of the light guide plate to the length of the LCD unit is 1.2 or higher.

4. The backlight unit of claim 1, wherein the light guide plate comprises a material selected from the group consisting of a glass, a polymer, and a combination thereof.

5. The backlight unit of claim 1, wherein the light guide plate comprises a glass having a thickness in a range of from about 0.01 mm to about 6 mm.

6. (canceled)

7. (canceled)

8. The backlight unit of claim 5, wherein the light guide plate is configured to be dynamically bendable to a minimum radius of curvature in a range of from about 100 mm to about 1,000 mm.

9. (canceled)

10. The backlight unit of claim 1, wherein the first light source comprises a plurality of discrete LEDs.

11. The backlight unit of claim 10, wherein each discrete LED has a length (Pw), and the plurality of discrete LEDs are disposed in a repeating pattern with a pitch (P) at a ratio of Pw/P in a range of from 0.5 to 0.95.

12. A display device, comprising:
a liquid crystal display (LCD) unit; and
a backlight unit, comprising:
a light guide plate having a first major surface, a second major surface opposite to the first major surface, and a first side wall surface between the first major surface and the second major surface; and
a first light source contacting or in proximity to the first side wall surface and optically coupled with the light guide plate,
wherein the light guide plate has a length greater than a length of the LCD unit, and the first light source has a length equal to or greater than the length of the LCD unit.

13. The display device of claim 12, wherein the length of the light guide plate is greater than the length of the first light source.

14. The display device of claim 12, wherein the light guide plate is configured to illuminate one or more additional LCD units.

15. The display device of claim 12, wherein the light guide plate comprises a material selected from the group consisting of a glass, a polymer, and a combination thereof.

16. The display device of claim 12, wherein the light guide plate comprises a glass, wherein the light guide plate has a thickness in a range of from about 0.01 mm to about 6 mm, and is configured to be dynamically bendable to a minimum radius of curvature in a range of from about 100 mm to about 1,000 mm.

17. (canceled)

18. The display device of claim 16, wherein a gap between the first light source and the first side wall surface is less than about 0.01 mm.

19. The display device of claim 12, wherein the first light source comprises a plurality of discrete LEDs.

20. The display device of claim 19, wherein each discrete LED has a length (Pw), and the plurality of discrete LEDs are disposed in a repeating pattern with a pitch (P) at a ratio of Pw/P in a range of from 0.5 to 0.95.

21. The display device of claim 2, further comprising one or more components selected from the group consisting of a light extractor, a reflector, at least one prismatic film, a touch panel, a cover lens, and combinations thereof.

22. (canceled)

23. (canceled)

24. (canceled)

25. A display device, comprising:
at least one liquid crystal display (LCD) unit; and
a backlight unit, comprising:
a light guide plate having a first major surface, a second major surface opposite to the first major surface, a first side wall surface between the first major surface and the second major surface; and
a first light source contacting or in proximity to the first side wall surface and optically coupled with the light guide plate,
wherein the light guide plate has a length greater than a length of the at least one LCD unit, and the first light source has a length equal to or greater than the length of the at least one LCD unit; and
the light guide plate comprises glass having a thickness in a range of from about 0.01 mm to about 0.7 mm, wherein the light guide plate is configured to be dynamically bendable to a minimum radius of curvature in a range of 100 mm to about 500 mm.

26. The display device of claim 25, wherein the light guide plate further comprises a second side wall surface opposite the first sidewall surface, and the backlight unit comprises a second light source contacting or in proximity to the second side wall surface and optically coupled with the light guide plate.

27. The display device of claim 26, wherein each of the first and the second light sources comprises a plurality of discrete LEDs, each discrete LED has a length (Pw), and the plurality of discrete LEDs are disposed in a repeating pattern with a pitch (P) at a ratio of Pw/P in a range of from 0.75 to 0.86.

28. (canceled)
